(19) United States
(12) Patent Application Publication
(10) Pub. No.: US 2018/0333889 A1
(43) Pub. Date: Nov. 22, 2018

(54) Driving Tool for Driving Fastening Means into Workpieces

(71) Applicant: Joh. Friedrich Behrens AG, Ahrensburg (DE)

(72) Inventor: Joachim Bauer, Bad Oldesloe (DE)

(73) Assignee: Joh. Friedrich Behrens AG, Ahrensburg (DE)

(21) Appl. No.: 15/982,153

(22) Filed: May 17, 2018

(30) Foreign Application Priority Data
May 19, 2017 (DE) 20 2017 103 050.4

(51) Int. Cl. B27F 7/09; B27F 7/13

(52) U.S. Cl. CPC B27F 7/09; B27F 7/13

(57) ABSTRACT

A driving tool for driving fastening means into workpieces comprising
a drive device in a housing,
an outlet tool protruding from the lower end of the housing with a driving channel,
a driving tappet that projects into the driving channel and is connected at the top to the drive device,
a magazine for fastening means that is attached to the driving channel in order to supply fastening means to the driving channel, and
a nail centering at the bottom on the outlet tool that has a centering opening that is limited by guide elements movable in the radial direction that are pretensioned toward the centering opening by at least one spring device,
characterized in that
   the nail centering comprises a centering housing in which at least one circle of balls is arranged, between which the centering opening is defined, and
   the spring device is an elastic ring that under pretensioning abuts the balls on the outside.

The invention relates to a driving tool for driving fastening means into workpieces.

Driving tools of the type according to the invention have a drive device in a tool housing and an outlet tool protruding from the lower end of the tool housing with a driving channel. A driving tappet projects into the driving channel and is connected at the top to the drive device. A magazine for fastening means is attached on the side to the driving channel in order to supply fastening means to the driving channel. When driving in nails or pins, a crooked alignment of the fastening means in the driving channel can cause an error in the alignment of the fastening means in the workpiece. This can be based on the fastening means partially filling the driving channel and being insufficiently guided. Moreover, in the case of nails, the nail tip can tip in relation to the wider nail head.

Driving tools with a nail centering on the lower end of the outlet tool are already known. In this case it is two flaps mounted in a hinged manner on the lower end of the outlet tool that are hinged together by springs. In the hinged together position, a centering opening is present between the two flaps. The nails being discharged from the driving channel are centered in the centering opening, wherein the flaps hinge away from each other somewhat when the wider nail head passes through. The centering opening has an oval cross-section shape for centering nails with different diameters. The disadvantage is that the springs fatigue differently so that the flaps are pressed together unevenly and centering errors occur. Moreover, the same nail centering can only be used for nails with slightly different diameters. Finally, the placement of the outlet tool onto a workpiece hinders the rebound of the flaps.

Against this background, the object of the invention is to provide a driving tool with a better centering of nails, pins and similar fastening means.

The object is solved by a driving tool with the features of claim 1. Advantageous embodiments of the driving tool are specified in the dependent claims.

The driving tool according to the invention for driving fastening means into workpieces comprises
a drive device in a housing,
an outlet tool protruding from the lower end of the housing with a driving channel,
a driving tappet that projects into the driving channel and is connected at the top to the drive device,
a magazine for fastening means that is attached to the driving channel in order to supply fastening means to the driving channel, and
a nail centering at the bottom on the outlet tool that has a centering opening that is limited by guide elements movable in the radial direction that are pretensioned toward the centering opening by at least one spring device,
   characterized in that
   the nail centering comprises a centering housing in which at least one circle of balls is arranged, between which the centering opening is defined, and
   the spring device is an elastic ring that under pretensioning abuts the balls on the outside.

When a nail, pin or similar fastening means is driven into a workpiece, the fastening means enters with its shaft into the centering opening of the nail centering after being discharged from the driving channel. When the shaft passes through the centering opening, the balls are pushed apart from each other radially against the effect of the elastic ring so that the shaft is centered. When the following nail head passes through, the balls are pushed farther apart from each other. When the fastening means has passed through the centering opening fully, the ring pushes the balls together again. The simultaneous abutment of multiple balls against the fastening means achieves a particularly exact centering. Moreover, fastening means with greatly differing diameters can be centered with the same centering device. Even as the ring gradually fatigues, the balls are pushed evenly against the fastening means and centering errors are avoided. A further advantage consists in that the outlet tool can be placed onto the workpiece with the underside of the centering housing in order to ensure an even driving depth and an alignment of the fastening means perpendicular to the workpiece surface.

According to one embodiment of the invention, the elastic ring is a snap ring. According to other embodiments, it is an O-ring or a Seeger circlip ring.

According to one embodiment of the invention, concentrically arranged circles of balls are arranged in the centering housing in at least one plane, wherein the centering opening is defined by the balls of an inner circle, the balls of an outer circle abut the balls of an inner circle, and a pretensioned elastic ring abuts the balls of an outer circle. The balls of the outer circle hereby serve to transfer the force exerted by the snap ring to the balls of the inner circle. This favors the use of elastic rings with a large diameter, long spring deflections and the usage of fastening means with different diameters.

According to another embodiment, the balls of the circle bordering the centering opening abut each other. This is the case in the initial state of the nail centering when no fastening means is discharged through the centering opening. This allows a simple construction of the nail centering. For adapting to the dimensions of the used fastening means, corresponding abutment surfaces of the centering housing can ensure in other embodiments that the balls do not abut each other in the initial state.

According to another embodiment, the balls from concentrically arranged circles abut each other on their equators. This is advantageous for the transfer of force.

According to another embodiment, the ring abuts the equator of the balls of a circle on the outside. This is also advantageous for the transfer of force.

According to another embodiment, the nail centering has multiple circles of balls arranged over each other that each border a centering opening. As a result, a fastening means being discharged through the nail centering is centered at two regions spaced apart from each other in the axial direction. A particularly exact centering is hereby achieved.

According to another embodiment, the nail centering has at least one arrangement of exactly two circles of balls arranged over each other and/or at least one arrangement of exactly two concentric circles of balls.

According to another embodiment, the centering housing is circular disk-shaped, has a central centering channel and in at least one plane multiple radial ball guiding channels that each start from the outer circumference of the centering housing and terminate in the centering channel, balls are arranged in the ball guiding channel, the centering housing has a circumferential groove on the outer circumference that cuts the outer ends of multiple ball guiding channels, and an elastic ring that under pretensioning abuts multiple balls on the outside is inserted into the groove, whereby balls between which the centering opening is defined are partially pushed into the centering channel. This embodiment is particularly easy to implement and robust from a constructive point of view. In the groove, the ring is centered in relation to the centering channel. Balls are spared by the radial ball guiding channels. According to another embodiment, the centering housing has exactly three ball guiding channels in each plane in which balls are arranged.

According to another embodiment, the centering housing has at least one radially extended threaded bore that is extended starting from the outer circumference to an extension on the upper end of the centering channel, the lower end of the outlet tool is inserted into the extension, and a clamping screw is inserted into the threaded bore by means of which the centering housing is firmly clamped on the outlet tool.

This achieves a particularly simple and reliable fixing of the nail centering on the outlet tool.

According to another embodiment, the underside of the centering housing is the lower end of the outlet tool, with which the pressing cylinder can be placed onto the workpiece. According to another embodiment, the underside of the centering housing is annulus-shaped. Marks from the outlet tool on the workpiece are hereby avoided since the centering housing can be placed onto the workpiece with a large area. Furthermore, driving in the fastening means perpendicular to the workpiece surface is promoted by the large-area abutment of the centering housing.

According to another embodiment, O-rings are arranged between the balls of an inner circle and the balls of an outer circle. Different diameters of mentioned balls and snap rings can hereby be compensated.

According to another embodiment, the drive device is designed so that it is driven by means of compressed air, by gas explosion or with electrical current. These embodiments are also termed compressed air nailers, gas pressure nailers or electronailers. The nail centering can also be used for driving tools with other drive devices.

According to another embodiment, the driving tool is a driving tool that can be handled with only one hand during use (manual tool) or a driving tool held on a displacement device or a stationarily arranged driving tool. A driving tool held on a displacement device can in particular be a driving tool arranged on a portal-like, traversable woodworking bridge.

According to another embodiment, the driving tool according to the invention for driving fastening means into workpieces has the following features:
a drive device with a translatorily displaceable drive element in a housing,
an outlet tool protruding from the lower end of the housing with a driving channel, that has an upper opening, a side opening and a lower opening for discharging fastening means,
a driving tappet that projects through the upper opening into the driving channel and is connected at the top with the drive element,
a magazine for fastening means that is attached to the side opening of the driving channel in order to supply fastening means to the driving channel, and
a nail centering at the bottom on the outlet tool that has a centering opening that is limited by at least one guide element movable in the radial direction that is pretensioned in the radial direction toward the centering opening by at least one spring device,
   characterized in that
   the nail centering comprises a centering housing in which at least one circle of balls is arranged, between which the centering opening is defined, and
   the spring device is an elastic ring that under pretensioning abuts the balls on the outside.

The preceding embodiment has advantageous features of one or more of the dependent claims or of the previously described embodiments.

The invention is explained in greater detail below based on the accompanying drawings of exemplary embodiments. In the drawings:

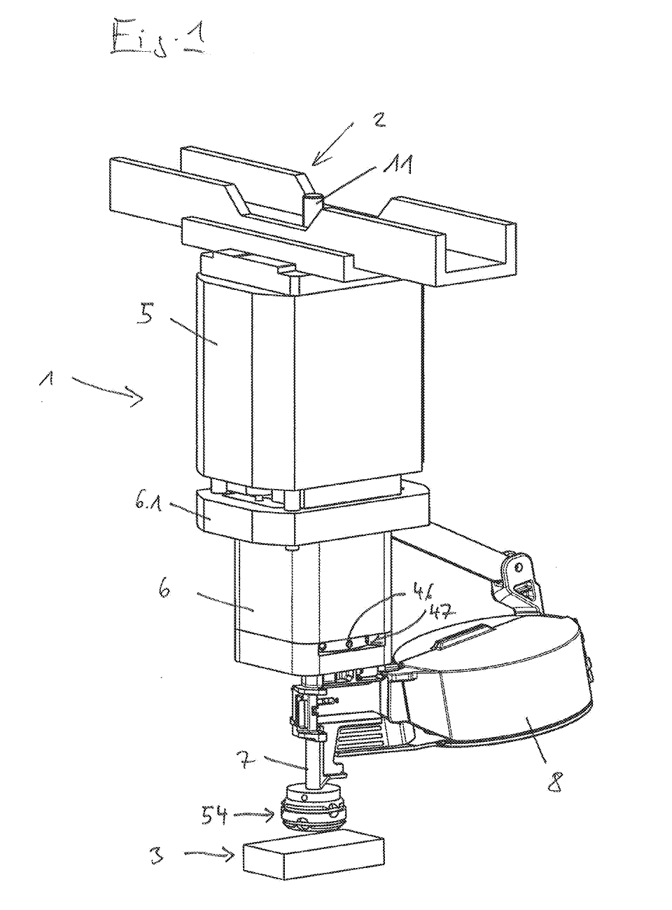

FIG. 1 shows a driving tool comprising a nail centering on a woodworking bridge in a perspective view transversely from the front and from the side;

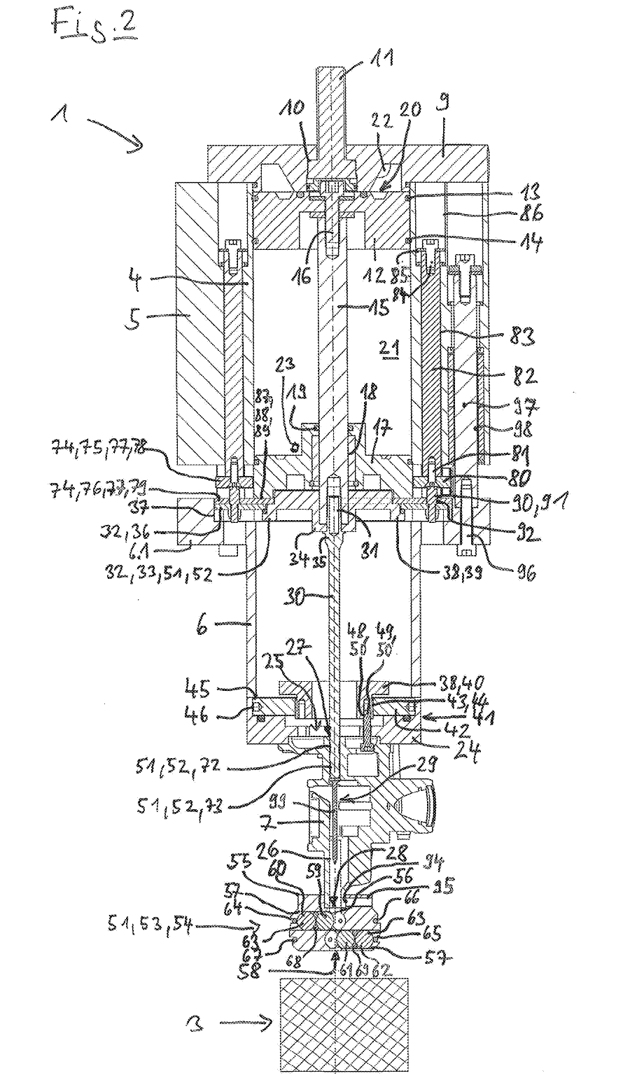

FIG. 2 shows a vertical section of the driving tool with the piston in the upper piston position;

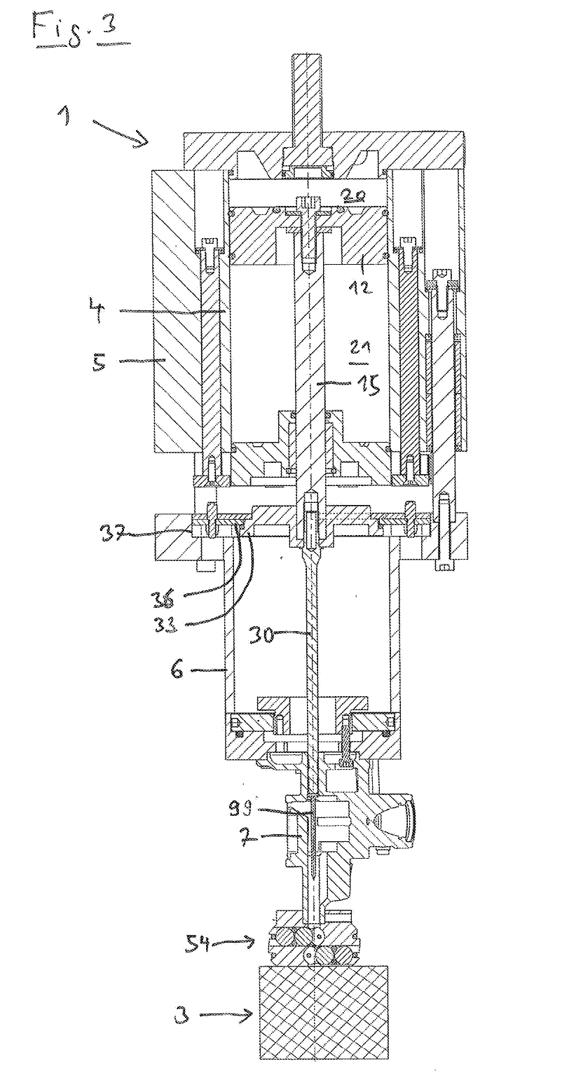

FIG. 3 shows a vertical section of the driving tool with the outlet tool set onto a workpiece;

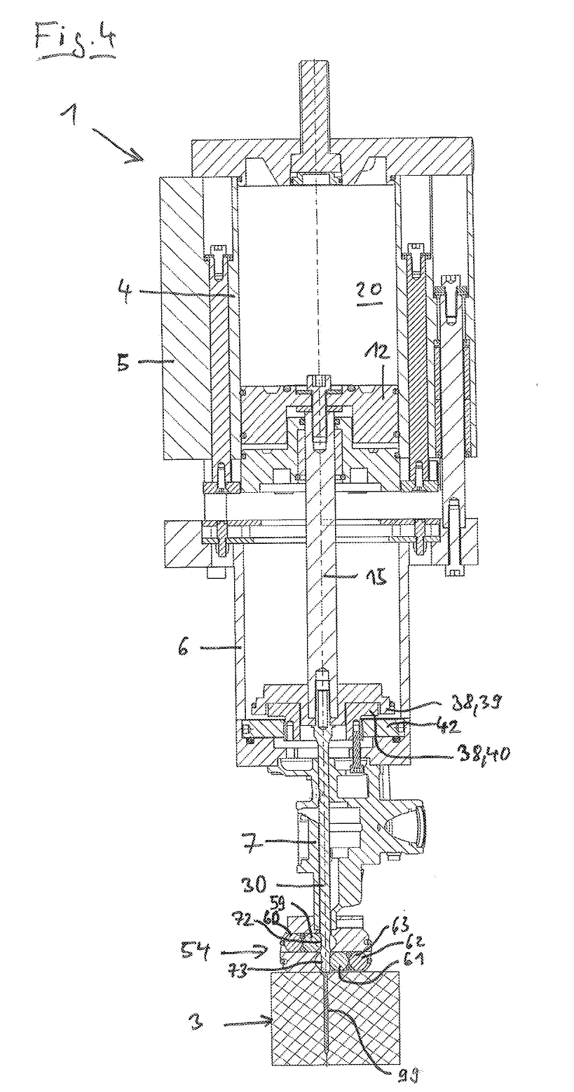

FIG. 4 shows a vertical section of the driving tool with a nail just fully driven into the workpiece;

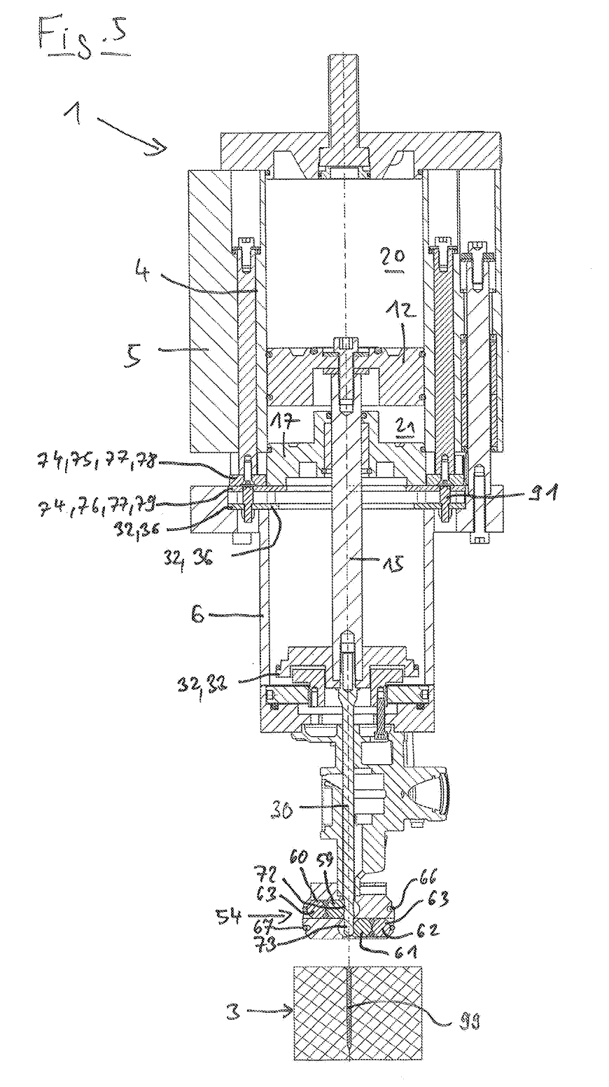

FIG. 5 shows a vertical section of the driving tool with the outlet tool pulled away from the workpiece and magnetically coupled main and pressing cylinders;

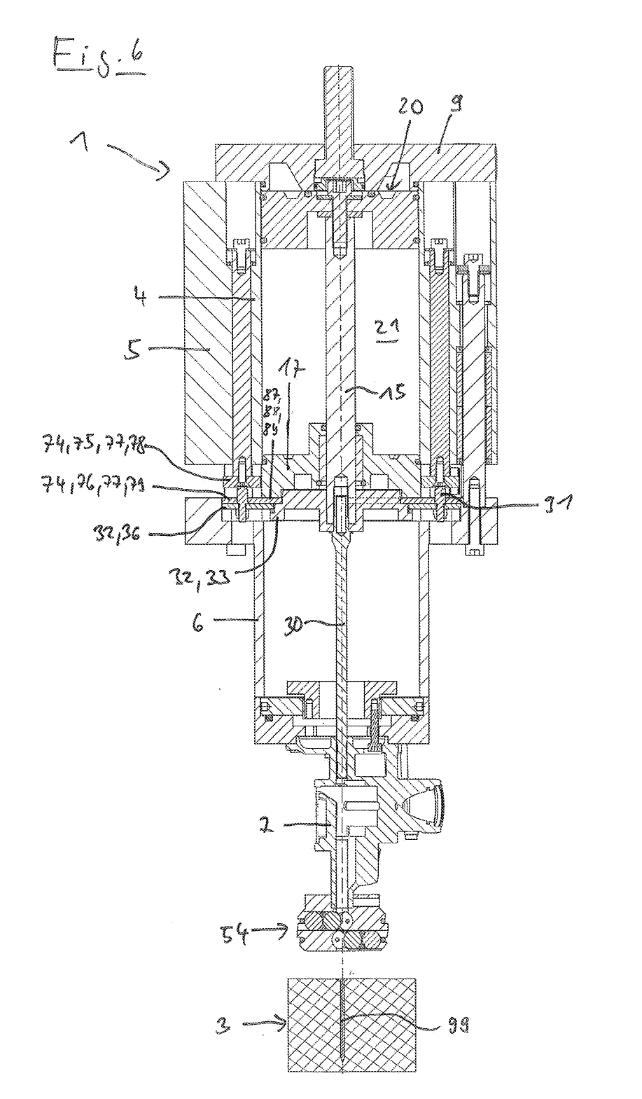

FIG. 6 shows a vertical section of the driving tool at the beginning of the mechanical coupling and releasing of the magnetic coupling of the main cylinder and pressing cylinder;

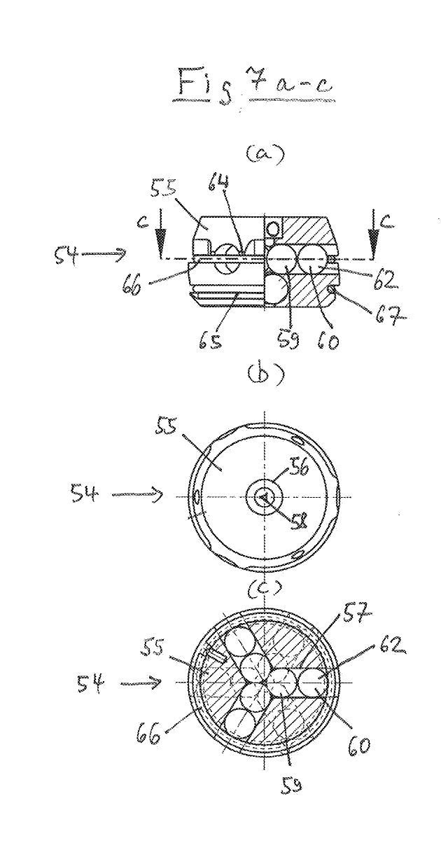

FIGS. 7a-c shows the nail centering of the second driving tool in a partially cut side view (FIG. 7a), in a plan view (FIG. 7b) and in a section along the line c-c from FIG. 7a (FIG. 7c).

In the present application, the indicators “up” and “down” and indicators derived therefrom such as “above” and “below” and “vertical” and “horizontal” refer to an orientation of the driving tool with the main cylinder over the pressing cylinder and the lower opening of the outlet tool on the lower end of the driving tool.

According to FIG. 1, a driving tool 1 is arranged on a bridge 2 above a workpiece 3. Only a horizontal support of the bridge 2 is shown. Overall, the bridge is portal-shaped, wherein the two vertical posts are guided displaceably in the horizontal direction on rails on both sides of a workbench.

According to FIGS. 1 and 2, the driving tool 1 comprises a main cylinder 4 in a housing 5, a pressing cylinder 6 arranged beneath the housing 5, an outlet tool 7 protruding downwards from the underside of the pressing cylinder, and a magazine 8 arranged to the side of the outlet tool. The pressing cylinder 6 has an outwardly protruding flange 6.1 at the top.

The main cylinder 4 is designed circular-cylindrically or ovally on the inside. The main cylinder 4 is closed at the top by a lid 9. In a central, hexagonal recess 10 in the underside of the lid 9, the hexagon head of a first screw 11 sits, the threaded shaft of which passes through a central bore in the lid 9 and protrudes from the lid 9 at the top. The first screw 11 serves for fastening to the bridge 2.

A piston 12 is guided vertically displaceably in the main cylinder 4. The piston is sealed off from the main cylinder 4 with first and second O-rings 13, 14.

A piston rod 15 protrudes downwards from the underside of the piston 12. The piston rod 15 is connected to the piston 12 by means of a second screw 16.

Underneath, the main cylinder 4 has a sealing element 17 that is designed as a first floor plate. The sealing element 17 has a first through hole 18 in the center in the form of a guide bushing, through which the piston rod 15 passes so that it stands out from the sealing element 17 at the bottom.

A third O-ring is held in a groove on the outer circumference of the sealing element 17 that seals off the sealing element from the main cylinder 4.

The piston rod 15 is sealed off from the sealing element 17 by a fourth O-ring 19 held in the sealing element 17.

Above the piston 12 a first air chamber 20 is present in the main cylinder 4 and below the piston 12 a second air chamber 21 is present. The first air chamber 20 is connected to a first air inlet 22 accessible from the outside and the second chamber is connected to a second air inlet 23 accessible from the outside.

The pressing cylinder 6 is substantially box-shaped on the outside and has a round or oval cross-section on the inside. The pressing cylinder 6 has a second floor plate 24 at the bottom with a second through hole 25.

The outlet tool 7 is fastened to the underside of the second floor plate 24. It has a driving channel 26 that has an upper opening 27 above, a lower opening 28 on the lower end of the outlet tool 7, and a side opening 29 on the side. The barrel-shaped magazine 8 for fastening means is attached with its output opening to the side opening 29.

A driving tappet 30 projects with a lower section through the second through hole 25 and the upper opening 27 into the driving channel 26. The upper section of the driving tappet 30 is fastened to the piston rod 15 at the bottom. For this, the driving tappet 30 has an external thread 31 at the top that is screwed into a threaded bore on the underside of the piston rod 15.

A first holding device 32 has a first holding element 33 protruding radially from the piston rod 15. It is hereby a circular disk-shaped projection running around the central axis of the piston rod. The first holding element 33 has a pot-shaped shaping 34 in the center into which the lower end of the piston rod 15 is inserted. The driving tappet 30 passes through a central hole of the shaping and is screwed into the piston rod 15. A collar 35 on the outer circumference of the driving tappet 30 abuts the underside of the shaping 34 so that the first holding element 33 is fixed between the piston rod 15 and driving tappet 30.

The first holding device 32 has a second holding element 36 connected to the pressing cylinder 6. The second holding element 36 is a projection protruding radially to the inside from the pressing cylinder 6. This projection is designed as an annular disk that is arranged vertically displaceably in a first expansion 37 on the upper end of the pressing cylinder 6.

A first stop device 38 has a first stop element 39 connected to the piston rod and a second stop element 40 connected to the pressing cylinder 6. The first holding element 33 is simultaneously the first stop element 39. The second stop element 40 is a ring that is held by a setting device 41 near the second floor plate 24.

The setting device 41 comprises an adjusting ring 42 that has an internal thread 43 into which the second stop element 40 is screwed with an external thread 44. In the region of the external thread 44, the second stop element 40 has a reduced outer diameter.

The underside of the adjusting ring 42 abuts the upper side of the second floor plate 24. At the top, the adjusting ring 42 is guided on a shoulder 45 of the pressing cylinder 6. Accordingly, the adjusting ring 42 is caught between the shoulder 45 and the second floor plate 24 so that it cannot be displaced vertically but can be rotated only about the vertical axis.

The adjusting ring 42 has multiple first blind bores 46 on the outer circumference into which a pin can be inserted from the outside through a slot 47 in the pressing cylinder 6 for twisting the adjusting ring 42 (FIG. 1). The second stop element 40 has multiple vertical threaded bores 48 on the underside into which studs 49 are screwed that are axially displaceably guided in second bores 24.1 of the second floor plate 24. The second bores 24.1 of the second floor plate 24 and the studs 49 form a linear guide 50.

By rotating the adjusting ring 42, the second stop element 40 can be displaced in the vertical direction since it is prevented by the studs 49 from rotating with the adjusting ring 42.

Furthermore, a second holding device 51 is present that has a third holding element 52 connected to the piston rod 15 and a fourth holding element 53 connected to the pressing cylinder 6. The fourth holding element 53 is a nail centering 54 on the lower end of the outlet tool 7.

The nail centering 54 has a circular disk-shaped centering housing 55 with a vertical centering channel 56 that is aligned with the driving channel 26 (FIG. 7). In the centering housing 55, two concentric circles 59, 60, 61, 62 of balls 63 are arranged in two horizontal planes over each other in each of three radial ball guiding channels 57 around a centering opening 58. The balls 63 of the two inner circles 59, 61 arranged over each other protrude partially into the centering channel 56, wherein adjacent balls 63 support each other and border a centering opening. Adjacent balls 63 of the outer circles 60, 62 and of the inner circles 59, 61 abut each other on their equator.

The centering housing 55 has on the outer circumference a circumferential groove 64, 65 in the equatorial plane of the upper circles 59, 60 and of the lower circles 61, 62 respectively that reach into the ball guiding channel 57 in the centering housing 55 in which the balls 63 are arranged. A snap ring 66, 67 sits in each groove 64, 65 that pushes under elastic pretensioning against the balls 63 of the outer circle 60, 62, which then push the balls of the inner circles 59, 61 into the centering channel 56 until they abut each other so that the centering opening 58 remains between the balls 63 of the inner circles 59, 61. In addition, 0-rings 68, 69 are arranged between the balls 63 of the inner circles 59, 61 and of the outer circles 60, 62 in order to compensate for different diameters of standardized balls 63 and snap rings 66, 67 so that the balls 63 of the inner circles 59, 61 each abut each other.

The fourth holding element 52 consists of circumferential grooves 72, 73 arranged over each other in a lower section of the driving tappet. In the vertical section, the grooves 72, 73 are lightly rounded, corresponding to the outer contour of the balls 63 of the nail centering 54. The spacing of the two grooves 72, 73 corresponds to the spacing from each other of the circles 59, 60, 61, 62 that are arranged over each other.

Furthermore, a third holding device 74 is present that has a fifth holding element 75 on the main cylinder 4 and a sixth holding element 76 on the pressing cylinder 6. The third holding device 74 comprises a magnetic coupling 77 that has a first magnetic coupling element 78 connected to the main cylinder 4 and a second magnetic coupling element 79 connected to the pressing cylinder 6. The first magnetic coupling element 78 has circular disk-shaped permanent magnets 80 that are fastened by means of fourth screws 81 to the lower ends of first bars 82 that are guided in vertical first bores 83 of the housing 5.

On the upper ends of the bars 82, first disks 85 are fastened, by means of fifth screws 84, that protrude to the outside radially in relation to the bars 82. The first disks 85 are arranged in second expansions 86 of the first bores 83 and limit the downward displacement of the first bars 82 by abutting an attachment on the lower end of the second expansions 86. The upward displacement of the first bars 82 is limited by the abutment of the permanent magnets 80 on the underside of the housing 5 protruding radially in relation to the first bars 82. The fourth magnetic coupling element 79 is designed from a ferromagnetic material as an annular disk that is fastened to the upper end of the pressing cylinder 6.

The third holding device 74 comprises a second stop device 87 that has a third stop element 88 on the main cylinder 4 and a fourth stop element 89 on the pressing cylinder 6. The fourth stop element 88 is a part of the second magnetic coupling element 79 protruding radially to the inside and the third stop element 89 is the underside of the sealing element 17.

The second magnetic coupling element 79 limits the upward displacement of the pressing cylinder 6 by abutting the underside of the sealing element 17. Furthermore, it covers the first expansion 37 of the pressing cylinder 6 at the top and limits the upward displacement of the second holding element 36. The downward displacement of the second holding element 36 is limited by the floor of the first expansion 37.

Furthermore, a retracting device 90 with vertically aligned pins 91 is present. The pins 91 protrude upwards from the upper side of the second holding element 36.

The pins 91 engage with holes 92 of the second magnetic coupling element 79. When the second holding element 36 is located in the lower location, the pins 91 do not protrude over the upper side of the second magnetic coupling element 79 (FIG. 3). By displacing the second holding element 36 upwards, the pins 91 are pushed out of the holes 92 at the top (FIG. 2).

A holder 93 of the magazine 8 is fastened to the pressing cylinder 6.

The lower end of the outlet tool 7 is inserted into an expansion 94 of the centering channel 56 of the nail centering 54 and is firmly clamped therein by means of a clamping screw screwed into a threaded bore 95.

The flange 6.1 of the pressing cylinder 6 is fastened by means of sixth screws 96 to second bars 97 that are guided in vertical third bores 98 in the housing 5.

FIGS. 1 and 2 show the first driving tool 1 in an initial position in which the outlet tool 7 does not sit with the nail centering 54 on the workpiece 3. The piston 12 is held by compressed air fed into the second air chamber 20 in the upper piston position in which it abuts the lid 9. The first holding element 33 is lifted maximally by the piston rod 15 so that the second holding element 36 abuts the underside of the sixth holding element 76. The first magnetic coupling element 78 is pushed away from the second magnetic coupling element 79 by the pins 91.

According to FIG. 3, the piston 12 and therefore the first holding element 33 is displaced downwards by feeding compressed air into the first air chamber 20 and ventilating the second air chamber 21. With the first holding element 33, the second holding element 36 and therefore the pressing cylinder 6 travels downwards until the outlet tool 7 sits with the nail centering 54 on the workpiece 3. A defined initial location for driving a nail 99 or another fastening means into the workpiece 3 is hereby given.

Afterwards, according to FIG. 4, further compressed air is introduced into the first air chamber 20 and a nail 99 fed into the driving channel 26 from the magazine 8 is driven into the workpiece 3 until the first stop element 39 abuts the second stop element 40. Then the nail 99 is driven into the workpiece 3 to a defined penetration depth. The penetration depth is determined by the vertical location of the second stop element 40 that can be set from the outside by twisting the adjusting ring 42.

When a nail 99 is discharged from the driving channel 26, the nail shaft is centered by the circles 59, 60, 61, 62 of balls 63 so that it just penetrates vertically into the workpiece 3. FIG. 4 shows the driving tool with a nail 99 driven in to the given penetration depth. The lower part of the driving tappet 30 also hereby engages with the centering channel 56. The balls 63 of the two inner circles 59, 61 engage with the two grooves 72, 73 and are held firmly therein by the snap rings 66, 67.

According to FIG. 5, the following upward displacement of the piston 12 over the nail centering 54 results in the outlet tool 7 and the pressing cylinder 6 also being lifted away upwards until the first magnetic coupling 74 couples.

The pressing cylinder 6 is hindered from a further upward displacement by the abutment of the sixth holding element 76 against the first floor plate 17 and the driving tappet 30 is pulled out of the nail centering 54. When the first holding element 33 hits the second holding element 36, the pins 91 release the first magnetic coupling 77. The pressing cylinder 6 is held firmly by the abutment of the first holding element 33 against the second holding element 36 and the second holding element 36 against the sixth holding element 76. This is shown in FIG. 6.

After feeding a further nail 99 from the magazine 8 into the driving channel 26, the driving tool 1 is ready for another driving process. This is shown in FIG. 2.

1. A driving tool for driving fastening means into workpieces comprising
a drive device (4, 12) in a housing (5),
an outlet tool (7) protruding from the lower end of the housing (5) with a driving channel (26),
a driving tappet (30) that projects into the driving channel (26) and is connected at the top to the drive device (4, 12),
a magazine (8) for fastening means (99) that is attached to the driving channel (26) in order to supply fastening means (99) to the driving channel (26), and
a nail centering (54) at the bottom on the outlet tool (7) that has a centering opening (58) that is limited by guide elements movable in the radial direction that are pretensioned toward the centering opening (58) by at least one spring device,
characterized in that
the nail centering (54) comprises a centering housing (55) in which at least one circle (59 to 62) of balls (63) is arranged, between which the centering opening (58) is defined, and
the spring device is an elastic ring (66, 67) that under pretensioning abuts the balls (63) on the outside.

2. The driving tool according to claim 1, in which the ring is an elastic snap ring (66, 67).

3. The driving tool according to claim 1, in which concentrically arranged circles (59 to 62) of balls (63) are arranged in the centering housing (55) in at least one plane, wherein the centering opening (58) is defined by the balls (63) of an inner circle (59, 61), the balls (63) of an outer circle (60, 62) abut the balls (63) of an inner circle (59, 61) and an elastic ring (66, 67) under pretensioning abuts the balls (63) of an outer circle (60, 62).

4. The driving tool according to claim 1, in which the balls (63) of the circle (59, 61) bordering the centering opening (58) abut each other.

5. The driving tool according to claim 1, in which balls (63) from concentrically arranged circles (59 to 62) abut each other on their equators.

6. The driving tool according to claim 1, in which the ring (66, 67) abuts on the outside the equator of the balls (63) of a circle (60, 62). 10

7. The driving tool according to claim 1, in which the nail centering (54) has multiple circles (59 to 62) of balls (63) arranged over each other that each border a centering opening (58).

8. The driving tool according to claim 1, in which the nail centering (54) has two concentrically arranged circles (59, 60) of balls (63).

9. The driving tool according to claim 1, in which the nail centering (54) has at least one arrangement of exactly two circles (59, 61) of balls (63) arranged over each other and/or at least one arrangement of exactly two concentric circles (59 to 62) of balls (63).

10. The driving tool according to claim 1, in which the centering housing (55) is circular disk-shaped, has a central centering channel (56) and in at least one plane multiple radial ball guiding channels (57) that each start from the outer circumference of the centering housing (55) and terminate in the centering channel (56), balls (63) are arranged in the ball guiding channels (57), the centering housing (55) has a circumferential groove (64, 65) on the outer circumference that cuts the outer ends of multiple ball guiding channels (57), and an elastic ring (66, 67) that under pretensioning abuts multiple balls (63) on the outside is inserted into the groove (64, 65), whereby balls (63) are partially pushed into the centering channel (56) between which the centering opening (58) is defined.

11. The driving tool according to claim 10, in which the centering housing (55) has exactly three radial ball guiding channels (57) in each plane in which balls (63) are arranged.

12. The driving tool according to claim 1, in which the centering housing (55) has at least one radially extended threaded bore (97) that is extended starting from the outer circumference to an extension (96) on the upper end of the centering channel (56), the lower end of the outlet tool (7) is inserted into the extension (96), and a clamping screw (98) is inserted into the threaded bore (97) by means of which the centering housing (55) is firmly clamped on the outlet tool (7).

13. The driving tool according to claim 3, in which elastic O-rings (68, 69) are arranged between the balls (63) of an inner circle (59, 61) and an outer circle (60, 62).

14. The driving tool according to claim 1 that is driven by means of compressed air, gas explosion or electrical current.

15. The driving tool according to claim 1 that is a driving tool (1) that can be handled with only one hand during use or a displaceable driving tool (1) held on a displacement device or a stationarily arranged driving tool (1).
